(19) United States
(12) Patent Application Publication
(10) Pub. No.: US 2025/0253358 A1
(43) Pub. Date: Aug. 7, 2025

(54) FUEL CELL STACK AND SEPARATOR FOR FUEL CELL

(71) Applicant: TOYOTA BOSHOKU KABUSHIKI KAISHA, Aichi-ken (JP)

(72) Inventors: Akihiro INUKAI, Okazaki-shi (JP); Yuto ITO, Takahama-shi (JP); Satoshi KAWABE, Ichinomiya-shi (JP); Haruyuki AONO, Aichi-ken (JP)

(73) Assignee: TOYOTA BOSHOKU KABUSHIKI KAISHA, Aichi-ken (JP)

(21) Appl. No.: 19/037,785

(22) Filed: Jan. 27, 2025

(30) Foreign Application Priority Data
Feb. 7, 2024 (JP) 2024-016976

(51) Int. Cl. H01M 8/0267; H01M 8/0221; H01M 8/026; H01M 8/0276; H01M 8/04029; H01M 8/10; H01M 8/2483

(52) U.S. Cl. CPC H01M 8/0267; H01M 8/0221; H01M 8/026; H01M 8/0276; H01M 8/04029; H01M 8/2483; H01M 2008/1095

(57) ABSTRACT

A fuel cell stack includes multiple stacked single cells. Each single cell includes a power generating unit, a frame member, a first separator, and a second separator. A gasket is provided between the first separator of a first single cell and the second separator of a second single cell. The first separator of the first single cell includes a first projection, and the second separator of the second single cell includes a second projection. The first projection and the second projection project so as to be in contact with each other, thereby suppressing flow of a cooling medium to the outside of the cooling passage. Aback face of at least one of the first projection and the second projection includes a flat surface section that is in contact with the frame member facing the back face.

### CROSS-REFERENCE TO RELATED APPLICATIONS

This application is based upon and claims the benefit of priority from Japanese Patent Application No. 2024-016976, filed on Feb. 7, 2024, the entire contents of which are incorporated herein by reference.

### BACKGROUND

### 1. Field

The present disclosure relates to a fuel cell stack and a separator for a fuel cell.

### 2. Description of Related Art

Japanese Laid-Open Patent Publication No. 2023-123116 discloses a fuel cell stack. The fuel cell stack disclosed in this publication includes multiple stacked single cells. Each single cell includes a power generating unit, a frame member disposed around the power generating unit to hold the power generating unit, a first separator, and a second separator. The first separator and the second separator sandwich the power generating unit and the frame member. Each of the first separator and the second separator includes a facing surface, which faces the power generating unit, and an opposite surface on the side opposite to the facing surface. The facing surface of the first separator is provided with a groove passage through which a first reactant gas flows. The facing surface of the second separator is provided with a groove passage through which a second reactant gas flows. The opposite surface of each of the first separator and the second separator is provided with a groove passage through which a cooling medium flows.

One of the stacked single cells is referred to as a first single cell, and a single cell having the second separator stacked on the first separator of the first single cell is referred to as a second single cell. In this case, the first separator of the first single cell is provided with first projections that protrude toward the second separator of the second single cell. The second separator of the second single cell is provided with second projections that protrude toward the first projections of the first separator. Each second projection is in contact with one of the first projections.

The first projections and the second projections are both located outward of the outermost parts of the flow passages in a width direction, which is orthogonal to both the extending direction of the groove passages and the stacking direction. The first projections and the second projections are both arranged side by side in the extending direction.

The first separator and the second separator are formed by pressing metal plates.

Since the first and second separators are formed by pressing metal plates, a recess is formed on the back face of each of the first projections on the first separator and the second projections on the second separator. Accordingly, a leakage flow of reactant gas may occur, in which reactant gas flowing through a groove passage leaks into these recesses through gaps between the frame member and the separator. This phenomenon reduces the amount of the reactant gas supplied to the power generating unit, decreasing the power generation efficiency. Therefore, it is necessary to suppress leakage flow of the reactant gas while suppressing leakage flow of the cooling medium.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell stack includes multiple stacked single cells. Each single cell includes a power generating unit, a frame member provided around the power generating unit to hold the power generating unit, and a first separator and a second separator sandwiching the power generating unit and the frame member. Each of the first separator and the second separator includes a facing surface and an opposite surface. The facing surface faces the power generating unit. The opposite surface is disposed on a side opposite to the facing surface. The facing surface of the first separator includes a first groove passage configured such that a first reactant gas supplied to the power generating unit flows through the first groove passage. The facing surface of the second separator includes a second groove passage configured such that a second reactant gas supplied to the power generating unit flows through the second groove passage. Each of the opposite surface of the first separator and the opposite surface of the second separator includes a cooling passage configured such that a cooling medium for cooling the power generating unit flows through the cooling passage. Any one of the stacked single cells is referred to as a first single cell. One of the stacked single cells that includes the second separator that is stacked on the first separator of the first single cell is referred to as a second single cell. A gasket is provided between the first separator of the first single cell and the second separator of the second single cell. The gasket surrounds the cooling passage and provides a seal between the first separator and the second separator. The first separator of the first single cell includes a first projection. The second separator of the second single cell includes a second projection. The first projection and the second projection are located between the cooling passage and the gasket and protrude so as to be in contact with each other, thereby suppressing flow of the cooling medium to an outside of the cooling passage. A back face of at least one of the first projection and the second projection includes a flat surface section that is in contact with the frame member facing the back face.

In another general aspect, a separator for a fuel cell is configured to be disposed to face a power generating unit of the fuel cell and a frame member that is provided around the power generating unit to hold the power generating unit. The separator includes a facing surface configured to face the power generating unit, and an opposite surface on a side opposite to the facing surface. The facing surface includes a groove passage configured such that a reactant gas supplied to the power generating unit flows through the groove passage. The opposite surface includes a cooling passage configured such that a cooling medium for cooling the power generating unit flows through the cooling passage. The opposite surface includes an attachment portion to which a gasket is attachable. The gasket surrounds the cooling passage and provides a seal between the separator and another separator stacked on the separator. The opposite surface includes a projection configured to be located between the cooling passage and the gasket. The projection projects so as to be in contact with the other separator thereby suppressing flow of the cooling medium to an outside of the cooling passage. Aback face of the projection includes a flat surface section configured to be in contact with the frame member.

Other features and aspects will be apparent from the following detailed description, the drawings, and the claims.

### BRIEF DESCRIPTION OF THE DRAWINGS

FIG. 1 is an exploded perspective view of a fuel cell stack according to an embodiment.

FIG. 2 is an exploded perspective view of a single cell shown in FIG. 1.

FIG. 3 is a plan view of an anode-side separator to which a gasket is bonded.

FIG. 4 is a bottom view of the anode-side separator shown in FIG. 3.

FIG. 5 is a cross-sectional view taken along line 5-5 of FIG. 2.

FIG. 6 is an enlarged plan view showing a main part of FIG. 3.

FIG. 7 is a cross-sectional view taken along line 7-7 of FIG. 6.

FIG. 8 is a plan view showing an anode-side separator according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

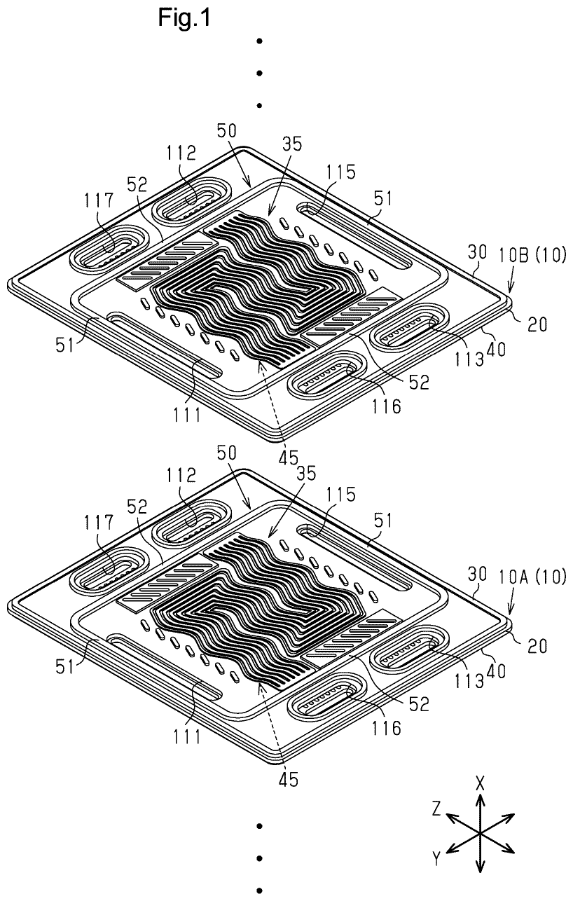

A fuel cell stack and a separator for a fuel cell according to an embodiment will now be described with reference to FIGS. 1 to 7.

For illustrative purposes, some components are shown exaggerated or simplified in the drawings. Therefore, the dimensional ratios of the components may differ from actual ratios.

As shown in FIG. 1, the fuel cell stack is formed by stacking multiple single cells 10. FIG. 1 shows two single cells 10A and 10B of the multiple single cells 10 forming the fuel cell stack.

### Single Cell 10

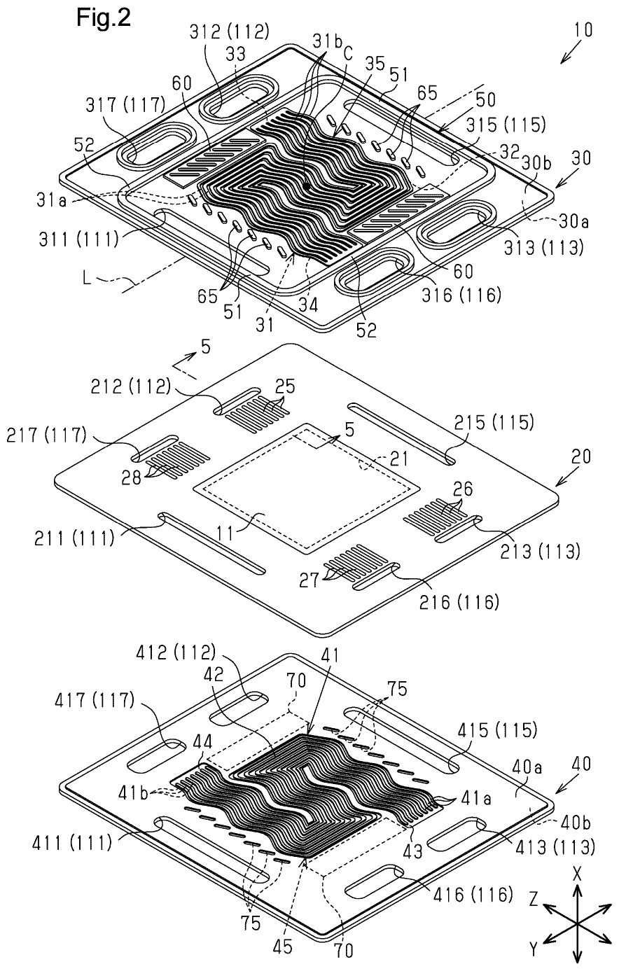

As shown in FIG. 2, each single cell 10 includes a membrane electrode assembly (hereinafter, referred to as a power generating unit 11), a frame member 20 provided around the power generating unit 11 to hold the power generating unit 11, and an anode-side separator 30 and a cathode-side separator 40 sandwiching the power generating unit 11 and the frame member 20. Each single cell 10 of the present embodiment has the shape of a rectangular plate as a whole.

In the following description, the stacking direction of the single cells 10 is referred to as a first direction X. In addition, a short side direction and a long side direction of the single cells 10 will be referred to as a second direction Y and a third direction Z, respectively. The first direction X, the second direction Y, and the third direction Z constitute a Cartesian coordinate system.

The single cell 10A corresponds to one of the single cells 10, and the single cell 10B corresponds to one of the single cells 10 that includes a cathode-side separator 40 stacked on the anode-side separator 30 of the single cell 10A. Hereinafter, the single cell 10A will be referred to as a first single cell 10A, and the single cell 10B will be referred to as a second single cell 10B.

As shown in FIGS. 1 and 2, each single cell 10 includes supply-side manifolds 111, 112, 113, which respectively supply cooling water, fuel gas, and oxidation gas into the single cell 10. Each single cell 10 also includes discharge-side manifolds 115, 116, 117, which respectively discharge cooling water, fuel gas, and oxidation gas in the single cell 10 to the outside.

The supply-side manifolds 111, 112, 113 and the discharge-side manifold 115, 116, 117 are formed through the single cell 10 in the first direction X.

The supply-side manifold 111 is provided on one side in the second direction Y (lower left side in FIGS. 1 and 2) of the single cell 10.

The discharge-side manifold 115 is provided on the other side in the second direction Y (upper right side in FIGS. 1 and 2) of the single cell 10.

The supply-side manifold 113 and the discharge-side manifold 116 are provided on one side in the third direction Z (lower right side in FIGS. 1 and 2) of the single cell 10. The supply-side manifold 113 and the discharge-side manifold 116 are arranged side by side in the second direction Y with a space in between.

The supply-side manifold 112 and the discharge-side manifold 117 are provided on the other side in the third direction Z (upper left side in FIGS. 1 and 2) of the single cell 10. The supply-side manifold 112 and the discharge-side manifold 117 are arranged side by side in the second direction Y with a space in between.

### Power Generating Unit 11

With reference to FIG. 2, the power generating unit 11 includes a solid polymer electrolyte membrane (hereinafter, referred to as an electrolyte membrane), and an anode electrode and a cathode electrode provided on the opposite surfaces of the electrolyte membrane.

The power generating unit 11 of the present embodiment has the shape of a rectangle having a pair of sides extending in the second direction Y and a pair of sides extending in the third direction Z. In FIG. 2, the anode electrode is disposed on the upper surface of the electrolyte membrane, and the cathode electrode is disposed on the lower surface of the electrolyte membrane.

### Anode-Side Separator 30

As shown in FIGS. 2 to 4, the anode-side separator 30 is disposed to face the anode electrode of the power generating unit 11.

The anode-side separator 30 includes supply-side manifolds 311, 312, 313 and discharge-side manifolds 315, 316, 317, which respectively form the supply-side manifolds 111, 112, 113 and the discharge-side manifolds 115, 116, 117.

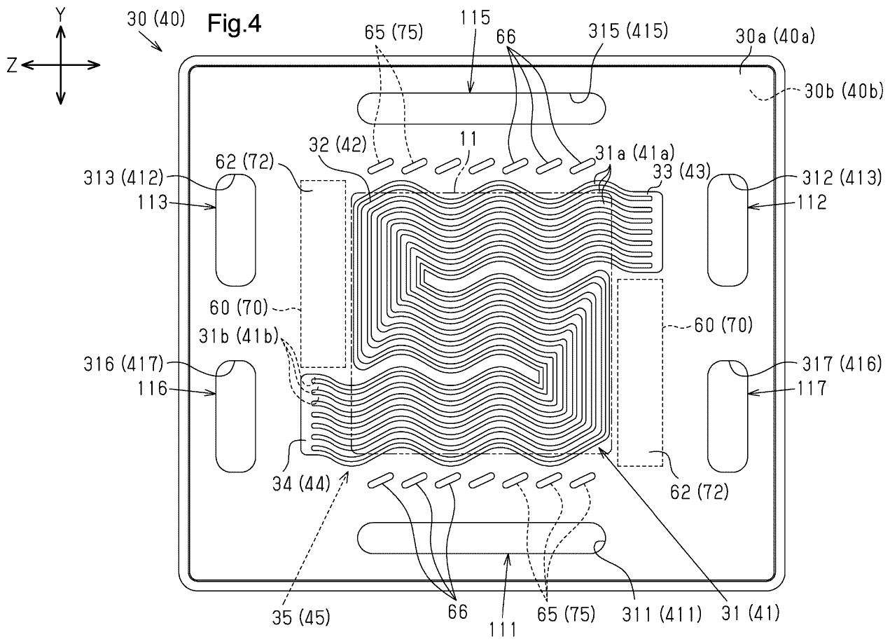

As shown in FIG. 4, the anode-side separator 30 includes a facing surface 30a, which faces the power generating unit 11. The facing surface 30a includes a first groove passage 31 for supplying the fuel gas to the power generating unit 11. The first groove passage 31 is formed by multiple grooves 31a provided on the facing surface 30a. The first groove passage 31 is located between the supply-side manifold 312 and the discharge-side manifold 316 in the third direction Z. The first groove passage 31 extends in a substantially S-shape from the supply-side manifold 312 toward the discharge-side manifold 316. Sections of the first groove passage 31 extending in the third direction Z have curved and wavy shapes.

The first groove passage 31 includes a power generation region 32, a supply-side connection region 33, and a discharge-side connection region 34. The power generation region 32 faces the power generating unit 11. The supply-side connection region 33 is located at an end portion of the first groove passage 31 that corresponds to the supply-side manifold 312. The discharge-side connection region 34 is located at an end portion of the first groove passage 31 that corresponds to the discharge-side manifold 316.

The power generation region 32 is located between the supply-side manifold 311 and the discharge-side manifold 315 in the second direction Y.

The supply-side connection region 33 is closer to the supply-side manifold 312 in the third direction Z than the power generating unit 11 is, and connects the power generation region 32 to the supply-side manifold 312.

The discharge-side connection region 34 is closer to the discharge-side manifold 316 in the third direction Z than the power generating unit 11 is, and connects the power generation region 32 to the discharge-side manifold 316.

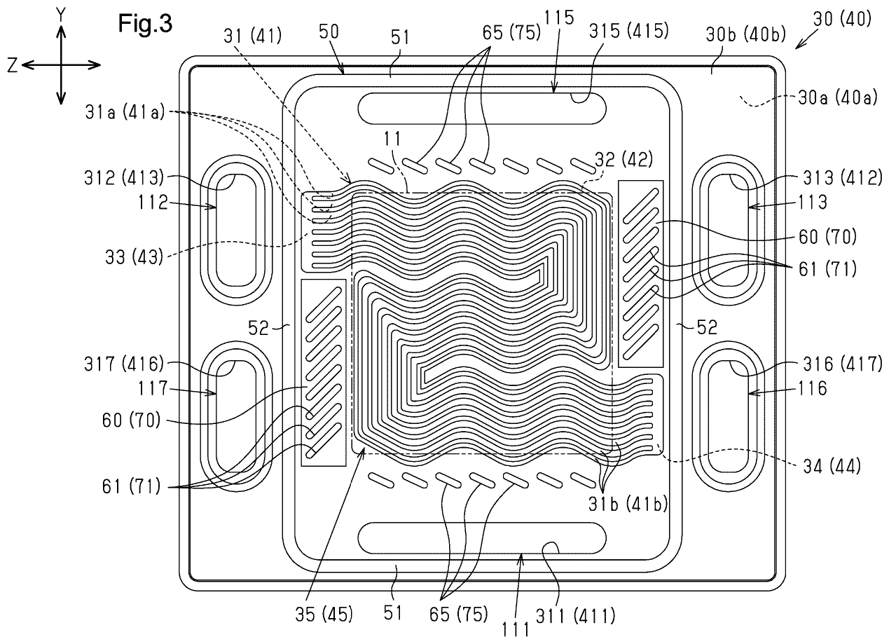

As shown in FIGS. 2 and 3, the anode-side separator 30 includes an opposite surface 30b on a side opposite to the facing surface 30a. Protrusions 31b are formed on the opposite surface 30b. The protrusions 31b extend along the grooves 31a, which form the first groove passage 31.

The opposite surface 30b includes a cooling passage 35, through which a cooling medium for cooling the power generating unit 11 flows. The cooling passage 35 is formed by grooves between adjacent ones of the protrusions 31b on a side of the power generation region 32 that corresponds to the opposite surface 30b.

The anode-side separator 30 is formed by hot-pressing a plastic plate containing a conductive material.

### Cathode-Side Separator 40

As shown in FIGS. 2 to 4, the cathode-side separator 40 is disposed to face the cathode electrode of the power generating unit 11.

The cathode-side separator 40 of the present embodiment has the same shape as the anode-side separator 30. The cathode-side separator 40 is arranged in an orientation equivalent to the anode-side separator 30 when inverted around an imaginary straight line L, which extends in the third direction Z and passes through the center in the second direction Y of the anode-side separator 30.

In the following description, some components of the cathode-side separator 40 may be referred to using reference numerals obtained by adding 10 to the reference numerals for the components in the anode-side separator 30, and redundant description may be omitted.

The cathode-side separator 40 includes supply-side manifolds 411, 412, 413 and discharge-side manifolds 415, 416, 417, which respectively form the supply-side manifolds 111, 112, 113 and the discharge-side manifolds 115, 116, 117.

As shown in FIG. 4, the cathode-side separator 40 includes a facing surface 40a, which faces the power generating unit 11. The facing surface 40a includes a second groove passage 41 for supplying the oxidation gas to the power generating unit 11. The second groove passage 41 is formed by multiple grooves 41a provided on the facing surface 40a. The second groove passage 41 is located between the supply-side manifold 413 and the discharge-side manifold 417 in the third direction Z. The second groove passage 41 extends in a substantially S-shape from the supply-side manifold 413 toward the discharge-side manifold 417. In addition, sections of the second groove passage 41 extending in the third direction Z have curved and wavy shapes.

The second groove passage 41 includes a power generation region 42, a supply-side connection region 43, and a discharge-side connection region 44. The power generation region 42 faces the power generating unit 11. The supply-side connection region 43 is located at an end portion of the second groove passage 41 that corresponds to the supply-side manifold 413. The discharge-side connection region 44 is located at an end portion of the second groove passage 41 that corresponds to the discharge-side manifold 417.

The power generation region 42 is located between the supply-side manifold 411 and the discharge-side manifold 415 in the second direction Y.

The supply-side connection region 43 is closer to the supply-side manifold 413 in the third direction Z than the power generating unit 11 is, and connects the power generation region 42 to the supply-side manifold 413.

The discharge-side connection region 44 is closer to the discharge-side manifold 417 in the third direction Z than the power generating unit 11 is, and connects the power generation region 42 to the discharge-side manifold 417.

As shown in FIGS. 2 and 3, the cathode-side separator 40 includes an opposite surface 40b on a side opposite to the facing surface 40a. Protrusions 41b are formed on the opposite surface 40b. The protrusions 41b extend along the grooves 41a, which form the second groove passage 41.

The opposite surface 40b includes a cooling passage 45, through which a cooling medium for cooling the power generating unit 11 flows. The cooling passage 45 is formed by grooves between adjacent ones of the protrusions 41b on a side of the power generation region 42 that corresponds to the opposite surface 40b.

The cathode-side separator 40 is formed by hot-pressing a plastic plate containing a conductive material.

### Gasket 50

As shown in FIGS. 1 and 2, a gasket 50 is provided between the anode-side separator 30 of the first single cell 10A and the cathode-side separator 40 of the second single cell 10B, and provides a seal between the anode-side separator 30 and the cathode-side separator 40. The gasket 50 surrounds the supply-side manifold 111, the discharge-side manifold 115, and the cooling passages 35, 45.

The gasket 50 is fixed to the opposite surface 30b of the anode-side separator 30 with, for example, an adhesive.

In the present embodiment, the gasket 50 has the shape of a rectangular frame in plan view, and has a pair of short sides 51 extending in the third direction Z and a pair of long sides 52 extending in the second direction Y

### Frame Member 20

As shown in FIG. 2, the frame member 20 includes an opening 21 at the center. The opening 21 is formed through the frame member 20 in the first direction X. The opening 21 of the present embodiment has the shape of a rectangle having a pair of sides extending in the second direction Y and a pair of sides extending in the third direction Z.

The peripheral edge of the power generating unit 11 is joined to the inner peripheral edge of the opening 21 from one side in the first direction X (the upper side in FIG. 2).

The frame member 20 includes supply-side manifolds 211, 212, 213 and discharge-side manifolds 215, 216, 217, which respectively form the supply-side manifolds 111, 112, 113 and the discharge-side manifolds 115, 116, 117.

The frame member 20 includes supply-side through-holes 25, 26 and discharge-side through-holes 27, 28 which are formed through the frame member 20 in the first direction X.

The supply-side through-holes 25, 26 and the discharge-side through-holes 27, 28 are elongated holes extending in the third direction Z.

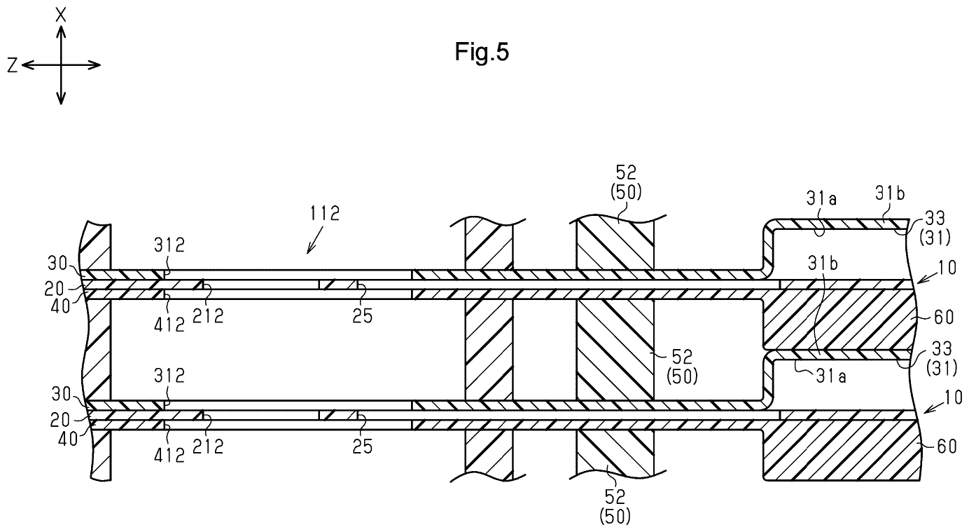

As shown in FIG. 5, the fuel gas flowing in the supply-side manifold 112 is supplied to the first groove passage 31 through the supply-side manifold 312 and the supply-side through-holes 25.

Although not illustrated, the off-gas of the fuel gas flowing through the first groove passage 31 is discharged to the discharge-side manifold 116 through the discharge-side through-holes 27 and the discharge-side manifold 316.

The oxidation gas flowing through the supply-side manifold 113 is supplied to the second groove passage 41 through the supply-side manifold 413 and the supply-side through-holes 26.

The off-gas of the oxidation gas flowing through the second groove passage 41 is discharged to the discharge-side manifold 117 through the discharge-side through-holes 28 and the discharge-side manifold 417.

The frame member 20 is made of a synthetic resin.

### Details of Configurations of Anode-Side Separator 30 and Cathode-Side Separator 40

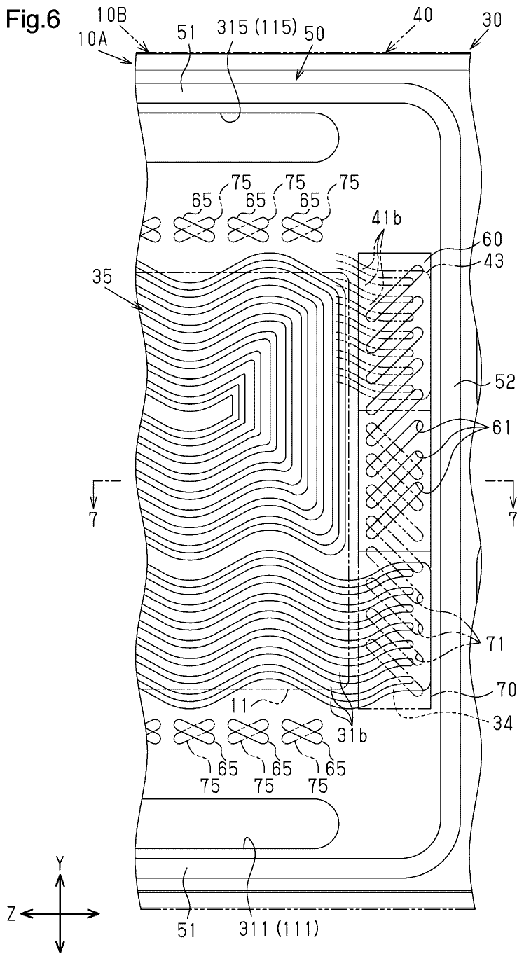

As shown in FIG. 6, the anode-side separator 30 includes first projections 60 and first ribs 65.

The first projections 60 and the first ribs 65 project away from the power generating unit 11. In the present embodiment, the first projections 60 and the first ribs 65 are arranged point-symmetrically with respect to a center C (see FIG. 2) in the plane direction of the anode-side separator 30. Accordingly, the description below will focus solely on the first projection 60 and the first ribs 65 located to the right of the power generating unit 11 in FIG. 6.

The first projection 60 is located between the cooling passage 35 and the long side 52 of the gasket 50 in the third direction Z. The first projection 60 is located closer to the discharge-side manifold 315 in the second direction Y than the discharge-side connection region 34 is.

The first projection 60 has the shape of a rectangle in plan view, and includes a pair of long sides extending in the second direction Y and a pair of short sides extending in the third direction Z.

As shown in FIG. 6, the first projection 60 of the first single cell 10A includes a portion that is in contact with a portion of the second single cell 10B (indicated by long-dash double-short-dash lines in FIG. 6) that corresponds to the supply-side connection region 43. Specifically, the first projection 60 is in contact with the protrusions 41b on the cathode-side separator 40.

Recesses 61 are provided in the front face of the first projection 60. In the present embodiment, the recesses 61 are elongated holes, and eight recesses 61 are provided in the front face of the first projection 60. The recesses 61 of the first single cell 10A extend so as to intersect with the protrusions 41b of the cathode-side separator 40 of the second single cell 10B indicated by the long-dash double-short-dash lines in FIG. 6. In the present embodiment, the recesses 61 are inclined so as to approach the discharge-side manifold 315 in the second direction Y as the recesses 61 extend toward the gasket 50 in the third direction Z.

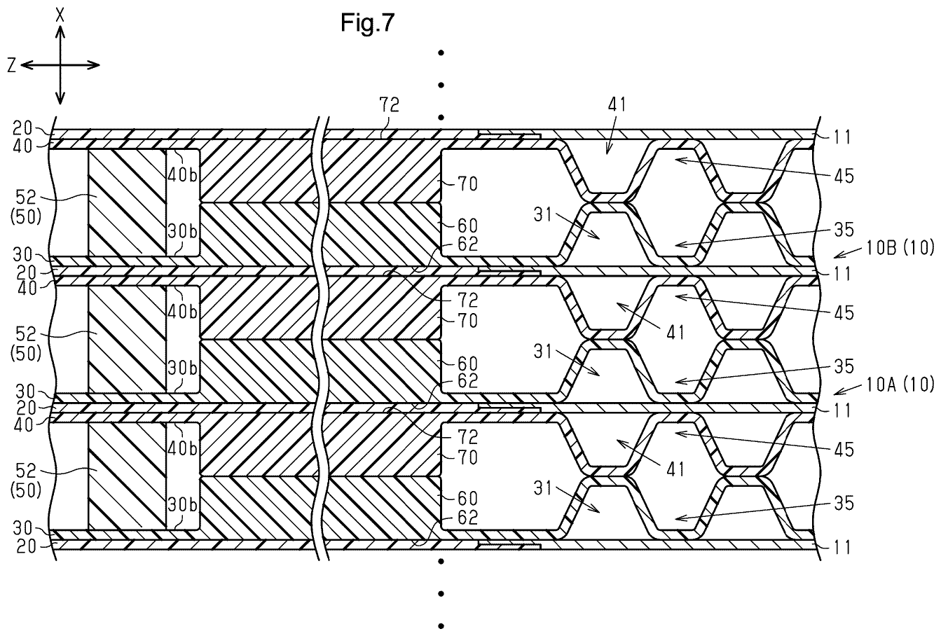

As shown in FIGS. 4 and 7, the back face of the first projection 60 is provided with a flat surface sections 62 that are in contact with the frame member 20, which faces the back face.

As shown in FIG. 6, two or more of the first ribs 65 are provided in each of a portion between the supply-side manifold 311 and the cooling passage 35 in the second direction Y and a portion between the discharge-side manifold 315 and the cooling passage 35 in the second direction Y In the present embodiment, seven first ribs 65 are provided in each of the portion between the supply-side manifold 311 and the cooling passage 35 in the second direction Y and the portion between the discharge-side manifold 315 and the cooling passage 35 in the second direction Y The first ribs 65 are spaced apart from each other in the third direction Z. The first ribs 65 are inclined so as to be separated from the discharge-side manifold 315 in the second direction Y as the first ribs 65 extend toward the supply-side manifold 313 in the third direction Z (refer to FIG. 3). A groove 66 is formed in the back face of each first rib 65 (see FIG. 4).

As described above, the cathode-side separator 40 of the present embodiment has the same shape as the anode-side separator 30. Therefore, second projections 70 and second ribs 75 are equivalent to the first projections 60 and the first ribs 65 of the anode-side separator 30 when inverted.

The second projection 70 of the cathode-side separator 40 of the second single cell 10B, which is indicated by the long-dash double-short-dash line in FIG. 6, is in contact with the first projection 60 of the anode-side separator 30 of the first single cell 10A and the protrusions 31b of the discharge-side connection region 34, which are indicated by the solid lines in FIG. 6. The recesses 71 of the second projection 70 on the cathode-side separator 40 of the second single cell 10B, which are indicated by the long-dash double-short-dash lines in FIG. 6, extend so as to intersect with the recesses 61 of the first projection 60 on the anode-side separator 30 of the first single cells 10A, which are indicated by the solid lines in FIG. 6. The recesses 71 of the cathode-side separator 40 of the second single cell 10B, which are indicated by the long-dash double-short-dash lines in FIG. 6, extend so as to intersect with the protrusions 31b of the discharge-side connection region 34 of the anode-side separator 30 of the first single cell 10A, which are indicated by the solid lines in FIG. 6.

The second ribs 75 of the cathode-side separator 40 of the second single cell 10B, which are indicated by the long-dash double-short-dash lines in FIG. 6, and the first ribs 65 of the anode-side separator 30 of the first single cells 10A, which are indicated by the solid lines in FIG. 6, contact each other and extend so as to intersect with each other.

In the present embodiment, the anode-side separator 30 and the cathode-side separator 40 correspond to a first separator and a second separator according to the present disclosure, respectively. Further, the fuel gas and the oxidation gas in the present embodiment correspond to a first reactant gas and a second reactant gas according to the present disclosure, respectively. In addition, a portion of the anode-side separator 30 to which the gasket 50 is bonded corresponds to an attachment portion to which a gasket is attachable according to the present disclosure.

### Operation of the Present Embodiment

As shown in FIG. 7, each first projection 60 of the anode-side separator 30 and the corresponding second projection 70 of the cathode-side separator 40 are in contact with each other. This suppresses flow of the cooling medium to the outside of the cooling passages 35, 45. In other words, leakage flow of the cooling medium is suppressed. This allows the cooling medium to cool the power generating unit 11 effectively.

In addition, the flat surface sections 62, 72 provided on the back faces of the first projections 60 and the second projections 70 are in contact with the frame member 20. This suppresses flow of the reactant gas to the outside of the groove passage 31, 41 through the gaps between the frame member 20 and the separators 30, 40. In other words, leakage flow of the reactant gas is suppressed.

### Advantages of the Present Embodiment

(1) The anode-side separator 30 of the first single cell 10A includes the first projections 60, which are each located between the cooling passage 35 and the gasket 50. The cathode-side separator 40 of the second single cell 10B includes the second projections 70, which are each located between the cooling passage 45 and the gasket 50. The back face of each first projection 60 includes the flat surface section 62, which is in contact with the frame member 20 facing the back face. The back face of each second projection 70 includes the flat surface section 72, which is in contact with the frame member 20 facing the back face. Each first projection 60 and the corresponding second projection 70 project so as to be in contact with each other, thereby suppressing flow of the cooling medium to the outside of the cooling passage 35, 45.

This configuration, which operates in the above-described manner, suppresses leakage flow of the reactant gas, while suppressing leakage flow of the cooling medium.
(2) The back face of each first projection 60 includes a flat surface section 62. The flat surface section 62 is in contact with the frame member 20, which faces the back face. The back face of each second projection 70 includes a flat surface section 72. The flat surface section 72 is in contact with the frame member 20, which faces the back face. In other words, the back faces of both the first projections 60 and the second projections 70 have the flat surface sections 62, 72, which are in contact with the frame member 20.

This configuration suppresses flow of the fuel gas to the outside of the first groove passage 31 through the gap between the frame member 20 and the anode-side separator 30. Further, the configuration suppresses flow of the oxidation gas to the outside of the second groove passage 41 through the gap between the frame member 20 and the cathode-side separator 40. Therefore, leakage flows of the fuel gas and the oxidation gas are suppressed.
(3) The anode-side separator 30 and the cathode-side separator 40 are made of plastic.

This configuration facilitates the formation of the anode-side separator 30 and the cathode-side separator 40, in which the flat surface sections 62, 72 are provided on the back faces of the first projections 60 and the second projections 70.
(4) Each first projection 60 includes the recesses 61 in the front face of the first projection 60. Each second projection 70 includes the recesses 71 in the front face of the second projection 70.

The thicknesses of the separators 30, 40, which are made of plastic, are partially increased by the flat surface sections 62, 72, which are in contact with the frame member 20, on the back faces of the first projections 60 and the second projections 70. As a result, molding defects may occur in the first projections 60 and the second projections 70. Consequently, each first projection 60 and the corresponding second projection 70 may fail to make proper contact with each other. Additionally, the flat surface sections 62, 72 may fail to make proper contact with the frame member 20.

In this regard, with the above-described configuration, each first projection 60 and the corresponding second projection 70, which have the flat surface sections 62, 72 on the back faces, have the recesses 61, 71 on the front faces. This suppresses the occurrence of molding defects due to a partial increase in thickness.
(5) The recesses 61 of the first single cell 10A extend so as to intersect with the protrusions 41b of the second single cell 10B. The recesses 71 of the second single cell 10B extend so as to intersect with the protrusion 31b of the first single cell 10A.

This configuration prevents the protrusions 41b from entering the recesses 61 of each first projection 60, and prevents the protrusions 31b from entering the recesses 71 of each second projection 70. As a result, the protrusions 41b, 31b are brought into proper contact with the first projections 60 and the second projections 70. This increases the surface pressure between the separators 30, 40 and the frame member 20. Accordingly, it is possible to suppress leakage flow of the reactant gas from the groove passage 31, 41 through gaps between the separators 30, 40 and the frame member 20.

### Modifications

The above-described embodiment may be modified as follows. The above-described embodiment and the following modifications can be combined as long as the combined modifications remain technically consistent with each other.

In the above-described embodiment, the recesses 61 of each first projection 60 and the recesses 71 of each second projection 70 extend so as to intersect with the protrusions 41b of the supply-side connection region 43 and the protrusions 31b of the discharge-side connection region 34, respectively. However, the present disclosure is not limited to this. The recesses 61 of each first projection 60 and the recesses 71 of each second projection 70 may extend along the protrusions 41b of the supply-side connection region 43 and the protrusions 31b of the discharge-side connection region 34, respectively.

In the above-described embodiment, each first projection 60 and each second projection 70 have portions that are in contact with the protrusions 41b of the supply-side connection region 43 and the protrusions 31b of the discharge-side connection region 34, respectively. However, the present disclosure is not limited to this. Each first projection 60 and each second projection 70 do not necessarily need to extend to positions at which the first projection 60 and the second projection 70 are in contact with the protrusions 41b of the supply-side connection region 43 and the protrusions 31b of the discharge-side connection region 34, respectively.

In the above-described embodiment, the recesses 61, 71 are formed as elongated holes. However, the shapes of the recesses 61, 71 may be, for example, circular shapes in plan view.

The recesses 61, 71 of the first projections 60 and the second projections 70 may be omitted if no molding defects occur in the first projections 60 and the second projections 70.

In the above-described embodiment, the first projections 60 and the second projections 70 are formed on the anode-side separator 30 and the cathode-side separator 40, respectively, by hot pressing a plastic plate containing a conductive material. However, the present disclosure is not limited to this. For example, the first projections 60 and the second projections 70, which are separate bodies, may be respectively joined to the anode-side separator 30 and the cathode-side separator 40, which are made of metal and in which the first groove passage 31 and the second groove passage 41 are formed by pressing.

In the above-described embodiment, the flat surface sections 62, 72, which are in contact with the frame member 20, are provided on the back faces of both the first projections 60 and the second projections 70. However, flat surface sections may be provided on the back faces of either the first projections 60 or the second projections 70.

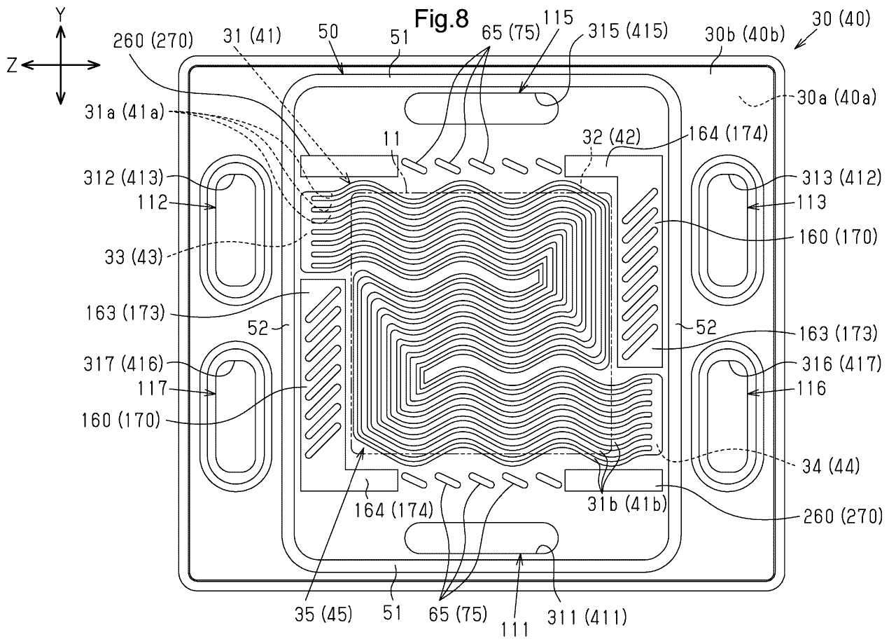

In the above-described embodiment, the first projections 60 are each provided only between the cooling passage 35 and one of the long sides 52 of the gasket 50 in the third direction Z. However, the present disclosure is not limited to this. A first projection may be provided between the cooling passage 35 and one of the short sides 51 of the gasket 50 in the second direction Y For example, as shown in FIG. 8, the anode-side separator 30 may include two sets of first projections 160, 260 on the opposite sides of and outside the supply-side manifold 311 in the third direction Z. Each first projection 160 includes a first section 163 and a second section 164. The first section 163 is located between the cooling passage 35 and one of the long sides 52 of the gasket 50 in the third direction Z, and extends to a position closer to the supply-side manifold 311 in the second direction Y than the cooling passage 35 is. The second section 164 protrudes inward in the third direction Z from an end of the first section 163 at the side corresponding to the supply-side manifold 311 in the second direction Y, and is located between the cooling passage 35 and one of the short sides 51 of the gasket 50 in the second direction Y The first projection 260 extends in the third direction Z to a position outside the cooling passage 35 in the third direction Z. The outer end of the first projection 260 in the third direction Z is adjacent to one of the long sides 52 of the gasket 50. The second section 164 of each first projection 160 and the first projection 260 are located closer to the cooling passage 35 than the supply-side manifold 311 is. Likewise, the cathode-side separator 40 includes two sets of second projections 170, 270 on the opposite sides of and outside the supply-side manifold 411 in the third direction Z. Each second projection 170 includes a first section 173 and a second section 174. The first section 173 is located between the cooling passage 45 and one of the long sides 52 of the gasket 50 in the third direction Z, and extends to a position closer to the supply-side manifold 411 in the second direction Y than the cooling passage 45 is. The second section 174 protrudes inward in the third direction Z from an end of the first section 173 at the side corresponding to the supply-side manifold 411 in the second direction Y, and is located between the cooling passage 45 and one of the short sides 51 of the gasket 50 in the second direction Y The second projection 270 extends in the third direction Z to a position outside the cooling passage 45 in the third direction Z. The outer end of the second projection 270 in the third direction Z is adjacent to one of the long sides 52 of the gasket 50. The second section 174 of each second projection 170 and the second projection 270 are located closer to the cooling passage 45 than the supply-side manifold 411 is.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising multiple stacked single cells, wherein
each single cell includes:
a power generating unit;
a frame member provided around the power generating unit to hold the power generating unit; and
a first separator and a second separator sandwiching the power generating unit and the frame member,
each of the first separator and the second separator includes a facing surface and an opposite surface, the facing surface facing the power generating unit, and the opposite surface being disposed on a side opposite to the facing surface,
the facing surface of the first separator includes a first groove passage configured such that a first reactant gas supplied to the power generating unit flows through the first groove passage,
the facing surface of the second separator includes a second groove passage configured such that a second reactant gas supplied to the power generating unit flows through the second groove passage,
each of the opposite surface of the first separator and the opposite surface of the second separator includes a cooling passage configured such that a cooling medium for cooling the power generating unit flows through the cooling passage,
any one of the stacked single cells is referred to as a first single cell,
one of the stacked single cells that includes the second separator that is stacked on the first separator of the first single cell is referred to as a second single cell,
a gasket is provided between the first separator of the first single cell and the second separator of the second single cell, the gasket surrounding the cooling passage and providing a seal between the first separator and the second separator,
the first separator of the first single cell includes a first projection,
the second separator of the second single cell includes a second projection,
the first projection and the second projection are located between the cooling passage and the gasket and protrude so as to be in contact with each other, thereby suppressing flow of the cooling medium to an outside of the cooling passage, and
a back face of at least one of the first projection and the second projection includes a flat surface section that is in contact with the frame member facing the back face.

2. The fuel cell stack according to claim 1, wherein
the back face of the first projection includes a flat surface section that is in contact with the frame member facing the back face of the first projection, and
the back face of the second projection includes a flat surface section that is in contact with the frame member facing the back face of the second projection.

3. The fuel cell stack according to claim 1, wherein the first separator and the second separator are made of plastic.

4. The fuel cell stack according to claim 3, wherein
the first projection includes a recess in a front face of the first projection, and
the second projection includes a recess in a front face of the second projection.

5. The fuel cell stack according to claim 4, wherein
the first groove passage includes:
a power generation region that faces the power generating unit;
a supply-side connection region that connects the power generation region to a supply-side manifold, the supply-side manifold being configured to supply the first reactant gas to the first groove passage; and
a discharge-side connection region that connects the power generation region to a discharge-side manifold, the discharge-side manifold being configured to discharge the first reactant gas from the first groove passage,
the second groove passage includes:
a power generation region that faces the power generating unit;
a supply-side connection region that connects the power generation region to a supply-side manifold, the supply-side manifold being configured to supply the second reactant gas to the second groove passage; and
a discharge-side connection region that connects the power generation region to a discharge-side manifold, the discharge-side manifold being configured to discharge the second reactant gas from the second groove passage,
multiple protrusions are formed on the opposite surface of the first separator, the protrusions extending along multiple grooves forming the first groove passage,
multiple protrusions are formed on the opposite surface of the second separator, the protrusions extending along multiple grooves forming the second groove passage,
the first projection of the first single cell includes a portion that is in contact with parts of the protrusions on the second separator of the second single cell, the parts of the protrusions corresponding to the supply-side connection region or the discharge-side connection region, and
the recess of the first projection of the first single cell extends so as to intersect with the protrusion of the second separator of the second single cell.

6. The fuel cell stack according to claim 4, wherein
the first groove passage includes:
a power generation region that faces the power generating unit;
a supply-side connection region that connects the power generation region to a supply-side manifold, the supply-side manifold being configured to supply the first reactant gas to the first groove passage; and
a discharge-side connection region that connects the power generation region to a discharge-side manifold, the discharge-side manifold being configured to discharge the first reactant gas from the first groove passage,
the second groove passage includes:
a power generation region that faces the power generating unit;
a supply-side connection region that connects the power generation region to a supply-side manifold, the supply-side manifold being configured to supply the second reactant gas to the second groove passage; and
a discharge-side connection region that connects the power generation region to a discharge-side manifold, the discharge-side manifold being configured to discharge the second reactant gas from the second groove passage,
multiple protrusions are formed on the opposite surface of the first separator, the protrusions extending along multiple grooves forming the first groove passage,
multiple protrusions are formed on the opposite surface of the second separator, the protrusions extending along multiple grooves forming the second groove passage,
the second projection of the second single cell includes a portion that is in contact with parts of the protrusions on the first separator of the first single cell, the parts of the protrusions corresponding to the supply-side connection region or the discharge-side connection region, and
the recess of the second projection of the second single cell extends so as to intersect with the protrusion of the first separator of the first single cell.

7. A separator for a fuel cell, the separator being configured to be disposed to face a power generating unit of the fuel cell and a frame member that is provided around the power generating unit to hold the power generating unit, the separator comprising:
a facing surface configured to face the power generating unit; and
an opposite surface on a side opposite to the facing surface, wherein
the facing surface includes a groove passage configured such that a reactant gas supplied to the power generating unit flows through the groove passage,
the opposite surface includes a cooling passage configured such that a cooling medium for cooling the power generating unit flows through the cooling passage,
the opposite surface includes an attachment portion to which a gasket is attachable, the gasket surrounding the cooling passage and providing a seal between the separator and another separator stacked on the separator,
the opposite surface includes a projection configured to be located between the cooling passage and the gasket, the projection projecting so as to be in contact with the other separator thereby suppressing flow of the cooling medium to an outside of the cooling passage, and
a back face of the projection includes a flat surface section configured to be in contact with the frame member.
